(19) United States
(12) Patent Application Publication
(10) Pub. No.: US 2004/0070510 A1
(43) Pub. Date: Apr. 15, 2004

(54) Radio frequency wetness detection system

(76) Inventors: Yimin Zhang, Somerset, NJ (US); Salvador Alvarado, Belle Mead, NJ (US); Zhixin Li, Bridgewater, NJ (US); Bodan Ma, Racine, WI (US)

Correspondence Address: Charles W. Almer, Counsel, I.P., NATIONAL STARCH AND CHEMICAL COMPANY, 10 Finderne Avenue, Bridgewater, NJ, 08807-0500, US

(21) Appl. No.: 10/271,900

(22) Filed: Oct. 15, 2002

(51) Int. Cl. G08B 21/00

(52) U.S. Cl. 340/618; 340/572.1

(57) ABSTRACT

A moisture monitoring device is provided having a resonant tag and a remote detector. The resonant tag comprises a plastic substrate having holes punched through it, a capacitor plate on one side that is connected to a second capacitor plate and inductor coils on the other side. The resonant tag comprises a live LC circuit having a natural resonant frequency that does not activate the detector. The resonant tag is affixed to absorbing materials in a diaper or other sanitary undergarment. Upon the introduction of moisture into the circuit, the resonant frequency is eliminated as the circuit is deactivated and an alarm in the detector is triggered. At this point it would be apparent to a parent or caretaker that the diaper is wet and in need of replacement.

### FIELD OF THE INVENTION

The invention relates to urine sensing devices and, more particularly, to urine sensing devices for use in diapers or other sanitary undergarments.

### BACKGROUND OF THE INVENTION

Monitoring the presence of urine in diapers and other sanitary undergarments has been a challenge for parents and caretakers for many years. In the event that the urine goes undetected for a prolonged period of time, the person wearing the diaper may develop a painful rash. However, it is not always readily apparent that the diaper is wet because there is no regular schedule for replacement of the diaper and the wearer often will not indicate that the diaper is wet and in need of replacement. Thus, it is often necessary to repeatedly loosen the diaper to check for urine. This action can lead to unnecessary replacement of the diaper due to damage caused during the inspection process. The result is that the diaper wearer is frequently disturbed, the caretaker often performs needless activity, and dry diapers are frequently discarded.

Numerous attempts have been made to provide diapers with signaling devices to avoid the problems discussed above. None of these attempts, however, have provided users with a low-cost, efficient urine monitoring system. For example, systems have been provided that utilize conductive electrodes wherein the resistance is reduced when urine is located between the electrodes. Systems such as this are not generally preferred because the electrodes are expensive to place within the diapers and are capable of producing a mild shock to the wearer under certain conditions. Thus, there is a need in the art for a urine monitoring device that will be inexpensive, safe and accurate.

### SUMMARY OF THE INVENTION

A urine monitoring system is provided having a resonant tag and a remote detector. The resonant tag comprises a plastic substrate having one or more holes punched through it, a capacitor plate on one side that is connected to a second capacitor plate and inductor coils on the other side. The resonant tag comprises a live LC circuit having a natural resonant frequency that, when inspected by the detector, does not cause the activation of the alarm incorporated in the detector. The resonant tag is affixed to absorbing materials in a diaper or other sanitary undergarment. Upon the introduction of urine into the circuit, the resonant frequency is altered as the circuit is deactivated and the alarm in the detector is activated. At this point it would be apparent to a parent or caretaker that the diaper is wet and in need of replacement.

### BRIEF DESCRIPTION OF THE DRAWINGS

FIG. 1 is a front view of a dry electric label.

FIG. 2 is a back view of a dry electric label.

FIG. 3 is a front view of an electric label containing urine.

FIG. 4 is a block diagram of the urine detecting system of the present invention.

### DETAILED DESCRIPTION OF THE PREFERRED EMBODIMENTS

The urine detection system of the present invention may be utilized with any form of garment for which it is desired to indicate the presence of urine, and will most commonly be utilized in reusable or disposable diapers or other forms of sanitary undergarments. While the system is primarily for detecting the presence of urine, the system may also be utilized to detect any other electrically conductive liquid, i.e., a liquid containing ions and/or electrolytes. Urine is electrically conductive in that it contains about 0.3% salt. In an alternative embodiment, the system may be utilized to detect non-electrically conductive liquids.

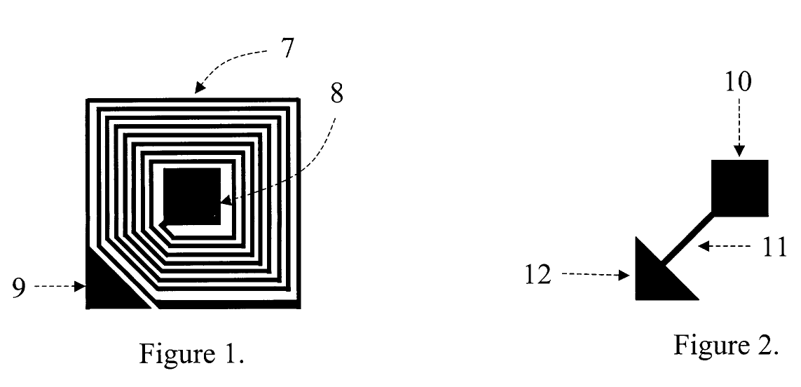

The urine detection system comprises a resonant tag, as illustrated in FIG. 1 and a detection means that is located remotely from the tag. The tag consists of a non-conductive dielectric substrate containing materials to create a resonant circuit. The substrate may consist of polyethylene, polypropylene, polyester or paper, and is preferably polyethylene or polypropylene. The front side of the resonant tag 5 includes a series of inducting coils 7. While the inducting coils are illustrated in the form of a square, they may be circular, rectangular or of other geometries depending upon the desired properties of the coils. The inducting coils may consist of conductive paste, a conductive polymer or a metal and are preferably conductive paste, typically a conductive paste comprising a mixture of silver flakes or powder, epoxy resin, and a cross-linking agent. The front side of the resonant tag also contains a capacitor plate 8 that is preferably located in the center of the inducting coils. The front side of the tag further includes an electrical junction 9 that is used to complete a resonant circuit with the opposite side of the tag. The circuitry may be applied to the substrate via various methods, including screen printing, lamination or lithography. The tag itself is then affixed, preferably through lamination, to the diaper or other desired material. The tag is affixed to the diaper or other material such that the front side is exposed, i.e., facing outwards from the material. Preferably, the tag is positioned so that it is in an area that is likely to come into contact with any bodily fluids that are given off by the wearer of the diaper.

The opposite side of the tag is located on the opposite side of the substrate. This side is illustrated in FIG. 2 and contains a second capacitor plate 10 that is connected to a junction 12 via wire 11. Through junction 9, the second capacitor and the connecting wire complete the resonant circuit of the tag with the first capacitor and the inducting coils. The intact tag absorbs electromagnetic waves at a resonant frequency of 1/2π√LC, with L representing the inductance and C representing the capacitance. The resonant frequency of the tag is dependent upon the materials chosen for the capacitor and inducting coils as well as the geometry of the circuit. A resonant frequency in the range of about 6 MHz to about 60 MHz is preferred, while a resonant frequency in the range of about 20 MHz to about 40 MHz is most preferred.

A remote detection means is provided that responds negatively to the normal resonant frequency of the intact tag. Numerous resonant frequency detecting devices are available and may be utilized with the present invention. U.S. Pat. Nos. 5,781,110; 6,177,870; and 3,810,147 all describe detection means that may be utilized for the present invention, and they are incorporated herein in their entirety. Generally, the detection means comprises a transmitter and a receiver. The transmitter emits a specific swept frequency over a range that includes the resonant frequency of the tag, through a transmitter antenna. A swept frequency in the range of about 6 MHz to about 60 MHz is preferred, while a swept frequency in the range of about 20 MHz to about 40 MHz is most preferred. The detection range, i.e., the distance at which the detection means can receive the resonant frequency of the tag, is determined by the resonant frequency of the tag and the power of the detection means. Higher power will allow placement of the detection means at a further distance from the tag, while those systems that provide a lower power will require that the detection means be placed closer to the tag. Preferably, the resonant frequency and swept frequency are compatible with the requirements of the Federal Communications Commission.

In use, the receiver antenna receives the swept frequency emitted by the transmitter and transmits it to the signal detector. The signals are routed through a RF filter that removes the components from the main oscillator. The signals are then processed through an amplifier and a digital processing unit in order to filter out any unwanted noise. The output of the digital processing unit energizes a relay switch that actuates the alarm if the normal swept frequency of the tag is not altered due to the absence of the resonant frequency of the tag. When the swept frequency is altered by the normal resonant frequency of the tag, the alarm is not activated. The alarm may be of any form, however it is preferably one that provides a sufficient signal, such as a noise or visual effect, so that the parent or caretaker may readily notice that the diaper is wet and in need of changing. The detection means may be powered by batteries or other electronic means, and preferably includes a power switch so that it can be turned off and on as desired by the user.

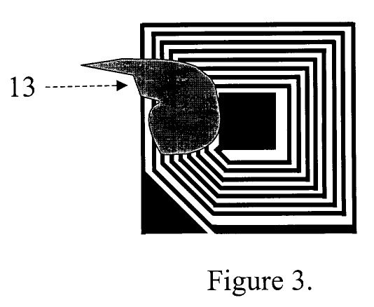

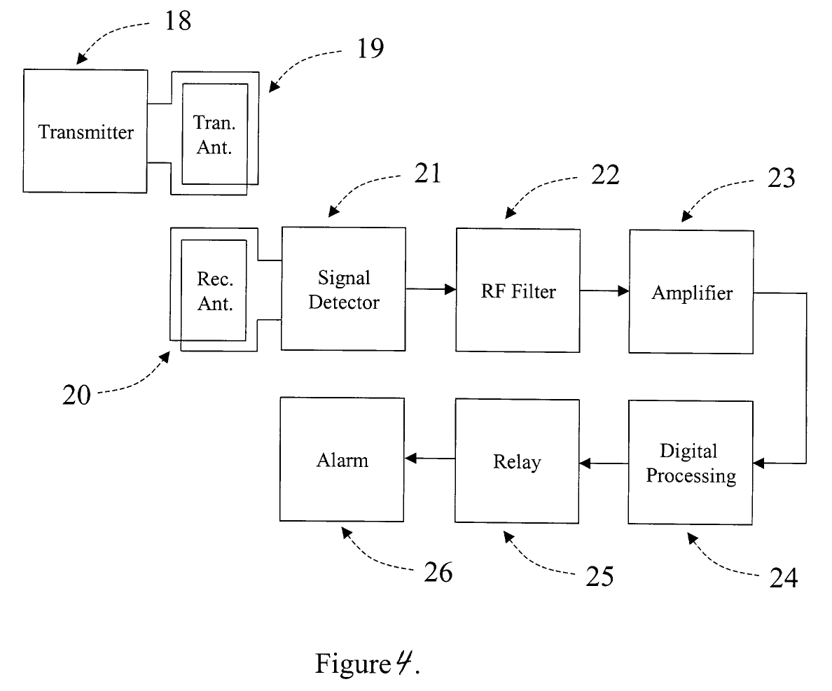

FIG. 3 illustrates an electrically conductive liquid 13, such as urine, contacting the inductor coils 7 of the tag. Before urine contacts the inductor, the swept frequency is altered by the tag's resonant frequency and this alteration is accounted for by the detection means so that the alarm is not triggered by a dry diaper. Once the urine contacts the inductor coils, the inductor is short-circuited and is destroyed. At this point, the resonant frequency is eliminated and the swept frequency transmitted by the tag is unchanged. The detection means responds positively to the constant, unchanged swept frequency and, doing so, emits the desired signal to alert the parent or caretaker of the need to change the diaper. This signal may be provided in virtually any desired form, including visual, such as the activation of a light, or audible, such as the activation of an alarm, buzzer or music. In the alternative embodiment for detecting the presence of non-electrically conducting liquids, the inducting coils comprise a water soluble material that dissolves upon contact with water or any other form of moisture to cause the elimination of the resonant frequency.

FIG. 4 outlines in a block diagram the manner in which the signal is generated and analyzed. Transmitter 18 emits a constant desired swept frequency signal. The swept frequency is transmitted from the transmitter via transmitter antenna 19 which is connected to the transmitter. The receiving antenna 20 is located at a distance from the transmitter antenna and receives the transmitted swept frequency signal. The receiving antenna is combined with a signal detector 21 that receives the incoming signal from the antenna. The signal detector is preferably attached to a RF filter 22 in order to filter out any unwanted noise or interference that is caused by the transmission. The signals are next routed preferably through amplifier 23 and digital processing unit 24 to maximize the clarity of the signal and filter out any remaining additional noise. The output of the digital processing unit energizes relay switch 25. In response to the signal caused by the normal resonant frequency of the tag the relay switch deactivates the alarm 26. Upon the introduction of urine to the tag the swept frequency is unaltered by the deactivated tag. The unchanged received signal ultimately reaches the relay switch which then activates the alarm to signal that the diaper requires replacement.

A further advantage of the detection system of the present invention and its activation upon the detection of an unchanged swept frequency is that the system will detect the absence of a diaper. Because the swept frequency detected by the detection means will be unaltered, when a diaper is accidentally not placed on a person the unchanged swept frequency will cause the activation of the alarm. This is especially beneficial in the situation where a caretaker has numerous individuals to monitor.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

We claim:

1. A system for detecting the presence of an electrically conductive liquid, wherein the system comprises (a) a passive resonant tag having a substrate, an inductor, and a capacitor comprising a LC circuit that provides a substantially constant resonant frequency that is eliminated when the inductor is contacted by an electrically conductive liquid, and (b) a remote detection means having a transmitter that emits a substantially constant swept frequency, an alarm, an antenna for receiving the swept frequency and means for processing the received swept frequency, wherein the detection means activates the alarm when the resonant frequency is eliminated.

2. The system of claim 1, wherein the substrate has a first side comprising an inductor and a capacitor and a second side comprising a capacitor.

3. The system of claim 2, wherein the substrate comprises a non-conductive dielectric material.

4. The system of claim 3, wherein the substrate comprises polyethylene, polypropylene, polyester or paper.

5. The system of claim 2, wherein the inductor is coil-shaped.

6. The system of claim 2, wherein the inductor comprises a conductive paste, a conductive polymer or a metal.

7. The system of claim 6, wherein the inductor comprises a conductive paste.

8. The system of claim 2, wherein the resonant frequency is in the range of about 6 MHz to about 60 MHz.

9. The system of claim 8, wherein the resonant frequency is in the range of about 20 MHz to about 40 MHz.

10. The system of claim 2, wherein the swept frequency is in the range of about 6 MHz to about 60 MHz.

11. The system of claim 10, wherein the swept frequency is in the range of about 20 MHz to about 40 MHz.

12. The system of claim 2, wherein the detection means further comprises a relay switch.

13. The system of claim 12, wherein the detection means further comprises an RF filter, an amplifier and a digital processing unit.

14. The system of claim 1, wherein the inductor and capacitor are affixed to the substrate via screen printing, lamination or lithography.

15. The system of claim 1, wherein the electrically conductive liquid is urine.

16. A sanitary undergarment comprising a system for detecting the presence of an electrically conductive liquid, wherein the system comprises (a) a passive resonant tag having a substrate, an inductor, and a capacitor comprising a LC circuit that provides a substantially constant resonant frequency that is eliminated when the inductor is contacted by an electrically conductive liquid, and (b) a remote detection means having a transmitter that emits a substantially constant swept frequency, an alarm, an antenna for receiving the swept frequency and means for processing the received swept frequency, wherein the detection means activates the alarm when the resonant frequency is eliminated.

17. The sanitary undergarment of claim 16, wherein the substrate has a first side comprising an inductor and a capacitor and a second side comprising a capacitor.

18. The sanitary undergarment of claim 17, wherein the substrate comprises a non-conductive dielectric material.

19. The sanitary undergarment of claim 18, wherein the substrate comprises polyethylene, polypropylene, polyester or paper.

20. The sanitary undergarment of claim 17, wherein the inductor is coil-shaped.

21. The sanitary undergarment of claim 17, wherein the inductor comprises a conductive paste, a conductive polymer or a metal.

22. The sanitary undergarment of claim 21, wherein the inductor is a conductive paste.

23. The sanitary undergarment of claim 17, wherein the resonant frequency is in the range of about 6 MHz to about 60 MHz.

24. The sanitary undergarment of claim 23, wherein the resonant frequency is in the range of about 20 MHz to about 40 MHz

25. The sanitary undergarment of claim 17, wherein the swept frequency is in the range of about 6 MHz to about 60 MHz.

26. The sanitary undergarment of claim 25, wherein the swept frequency is in the range of about 20 MHz to about 40 MHz.

27. The sanitary undergarment of claim 17, wherein the detection means further comprises a relay switch.

28. The sanitary undergarment of claim 27, wherein the detection means further comprises an RF filter, an amplifier and a digital processing unit.

29. The moisture detection system of claim 16, wherein the inductor and capacitor are affixed to the substrate via screen printing, lamination or lithography.

30. The sanitary undergarment of claim 29, wherein the detection means further comprises an RF filter, an amplifier and a digital processing unit.

31. The sanitary undergarment of claim 16, wherein the sanitary undergarment comprises a diaper.

32. The sanitary undergarment of claim 16, wherein the electrically conductive liquid is urine.

33. A system for detecting the presence of a liquid, wherein the system comprises (a) a passive resonant tag having a substrate, an inductor, and a capacitor comprising a LC circuit that provides a substantially constant resonant frequency that is eliminated when the inductor is contacted by an electrically conductive liquid, and (b) a remote detection means having a transmitter that emits a substantially constant swept frequency, an alarm, an antenna for receiving the swept frequency and means for processing the received swept frequency, wherein the detection means activates the alarm when the resonant frequency is eliminated and wherein the inductor comprises a water-soluble material.
